(19) United States
(12) Patent Application Publication
(10) Pub. No.: US 2018/0103119 A1
(43) Pub. Date: Apr. 12, 2018

(54) System and method for pairing devices to complete a task using an application request.

(71) Applicants: Synergex Group, Greenwich, CT (US); Wayne Taylor, Chandler, AZ (US); Pham Holdings, Inc., Lacey, WA (US)

(72) Inventor: Thien Pham, Lacey, WA (US)

(73) Assignees: Synergex Group, Greenwhich, CT (US); Wayne Taylor, Chandler, AZ (US); Pham Holdings, Lacey, WA (US)

(21) Appl. No.: 15/291,023

(22) Filed: Oct. 11, 2016

(51) Int. Cl. H04L 29/08

(52) U.S. Cl. CPC H04L 67/327; H04L 67/141

(57) ABSTRACT

System and method for pairing devices to complete a task using an application request.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates generally to two computer programs that enable a user to complete a task by first creating an application request consisting of a unique identifier, current date and time, passcode, IP address, status, request type, data and user unique identifier. The completing application completes the application request by setting the status of the application request to complete and update the data of the application request.

### BACKGROUND OF THE INVENTION

Completing a task on a device such as a computer is easy if the computer has the necessary hardware and data available on that computer. There are times where a device cannot perform a task because it lacks the hardware or missing data. An example is a desktop computer without a camera and the application requires a picture of an object. For this to be accomplished, a device with a camera is needed to complete the task and transmit that data to the computer. With current pairing technology that exists today, such as Bluetooth and Near Field Communication (NFC), it is difficult to use and requires the user to pair the devices first before the transmission of data can be accomplish. The process of pairing devices and running specific applications is difficult to use and near impossible for certain users to understand.

What is needed is a system and method for automatic pairing devices to complete a task using an application request.

### BRIEF SUMMARY OF THE INVENTION

In a typical application, a user accesses an application on a device that requires a photo, digital file, payment information, signature, or any other data. The application requests the user to provide the necessary information and a button in the application allows the user to use a secondary device to provide the information. The user clicks the button and an information screen appears, giving the user instructions how to use a secondary device to provide the information. The user then opens an application hosted on the secondary device. The application on the secondary device connects to a database server and provides necessary information to retrieve the application request and opens the necessary action screen to complete the application request by updating the data of the application request stored in database server and ends.

### BRIEF DESCRIPTION OF THE SEVERAL VIEWS OF THE DRAWING

FIG. 1 illustrates an exemplary environment for completing a task using a secondary device.

FIG. 2 illustrates the method for creating an application request, checking the application request status equal to 1, retrieving the data from the database server.

FIG. 3 illustrates the method for completing the requested task by getting the necessary data and submitting the data to the database server.

### DETAILED DESCRIPTIONS OF THE INVENTION

The invention is now described in detail with reference to an embodiment thereof as illustrated in the accompanying drawing. In the following description, numerous specific details are set forth in order to provide thorough understanding of the present disclosure. It is apparent, however, to one skilled in the art, that the present discloser may be practiced without some or all of these specific details. In other instances, well known process steps and/or structures have not been described in detail in order not to unnecessarily obscure the present disclosure. In addition, while the disclosure is described in conjunction with the particular embodiment, it should be understood that this description is not intended to limit the disclosure to the described embodiment. To the contrary, the description is intended to cover alternatives, modifications, and equivalents as may be included within the spirit and scope of the disclosure as defined by the appended claims.

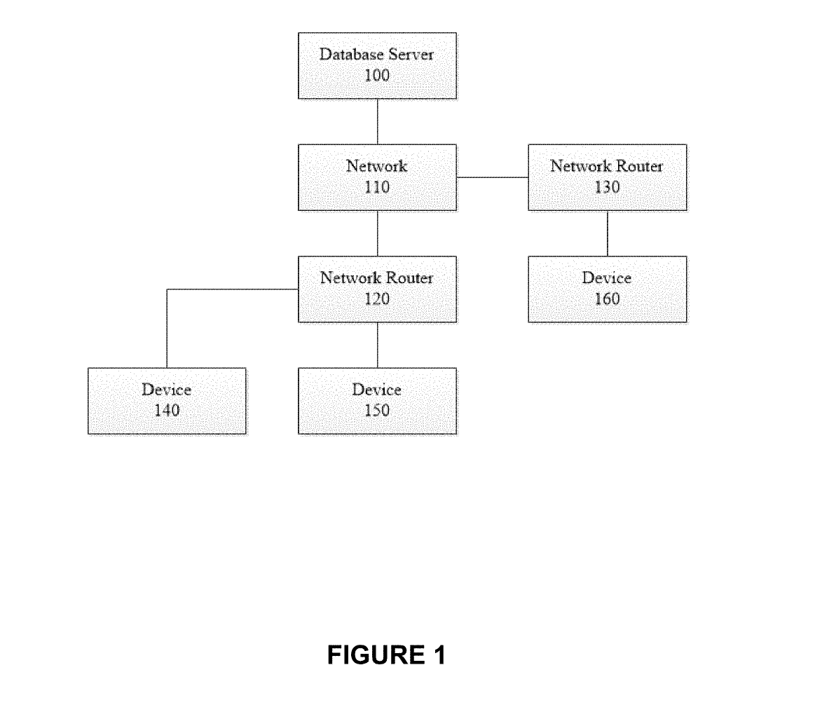

FIG. 1 illustrates an exemplary environment for completing a task using a secondary device.

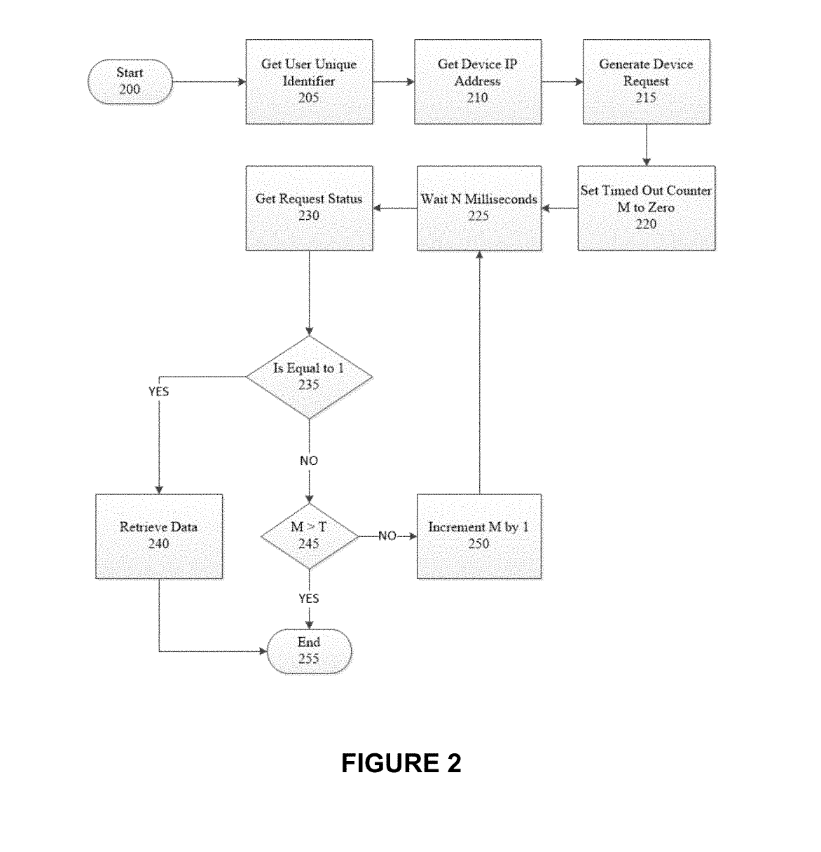

FIG. 2 illustrates the method for creating an application request, checking the application request status equal to 1, retrieving the data from the database server.

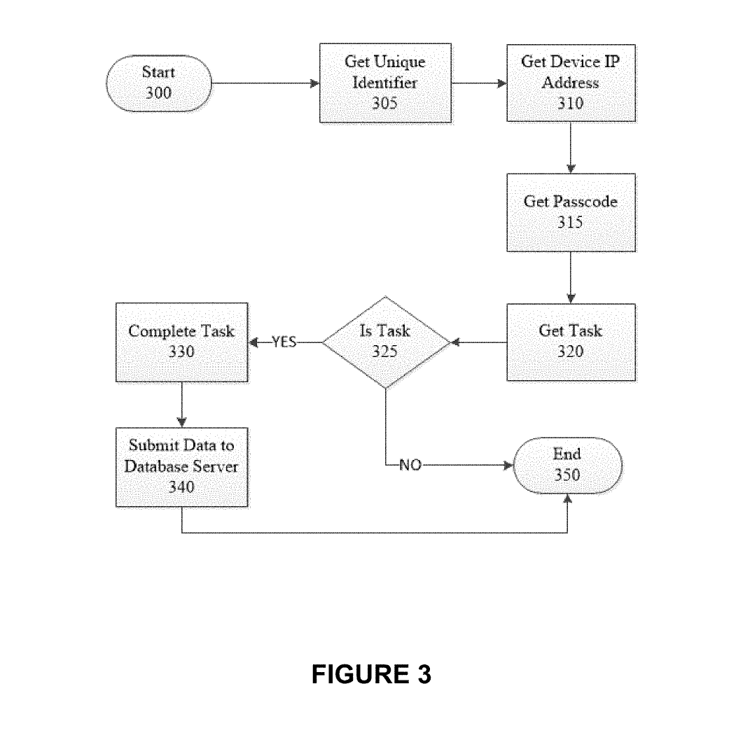

FIG. 3 illustrates the method for completing the requested task by getting the necessary data and submitting the data to the database server.

A system and method for pairing devices to complete a task using an application request consisting of a unique identifier, current date and time, passcode, Internet Protocol (IP) address, status, request type, data and user unique identifier is provided.

FIG. 1 illustrates an exemplary environment in which the requesting application runs on device 140. Device 140 is coupled to database server 100 via network router 120 and network 110. The task completing application runs on device 150 and device 160. Device 150 is coupled to database server 100 via network router 120 and network 110. Device 160 is coupled to database server 100 via network router 130 and network 110. The requesting application running on device 140 creates an application request consisting of a unique identifier, current date and time, passcode, IP address, status, request type, data and user unique identifier and stores it to database server 100 and waits for either device 150 or device 160 running the task completing application to complete the application request by setting the status to 1 and updating the data of the application request. Device 150 is on the same network as device 140. Device 160 is not on the same network as device 140. The task completing application can run on any device and can be connected to any network router as long as it can connect to the database server 100. An example is the task completing application running on a mobile device that is connected to a cellular network where that cellular network is connected to the Internet with connectivity to database server 100. The present invention is not limited to having the plurality of devices connected to the same network router running the same task completing application.

FIG. 2 illustrates the method for creating an application request, checking the application request status equal to 1, retrieving the data from database server 100, and ending the program. The program starts at Step 200 and continues to Step 205, where the program retrieves the user unique identifier that was stored in device memory when the user last successfully signed into the application. The unique identifier is not limited to the user's username or id. It can be any user identifiable data specified by the application. The program then continues to Step 210, where it retrieves the device Internet Protocol (IP) address and continues to Step 215. At Step 215, the program uses the user unique identifier of Step 205 and the IP Address of Step 210 to create an application request consisting of a unique identifier of the application request, current date and time, passcode, IP address, status, request type, data and user unique identifier. Next, the program generates a unique alphanumeric string for the passcode of the created application request, sets the IP address of the created application request to the IP Address of the network router that the device is connected to, sets the status of the created application request to 0, and sets the request type of the created application request type to a task the program is requesting for and stores it to database server 100. The program then continues to Step 220. At Step 220, the program sets the timed out counter M to zero. M is greater than or equal to 0. The program then continues to Step 225. At Step 225, the program waits N milliseconds, where N is greater than or equal to 1. Once the program completes waiting for N milliseconds, the program continues to Step 230. At Step 230, the program connects to database server 100 via the network router 120 and the network 110 to retrieve the device request status of Step 215 using the device request unique identifier of Step 215. The program then continues to Step 235, where it checks the device request status retrieved at Step 230 is equal to 1. If the device request status retrieved at Step 230 is equal to 1, the program continues to Step 240. At Step 240, the program connects to database server 100 via the network router 120 and the network 110 and retrieves the data that was stored to database server 100 at Step 340 using the device request unique identifier of Step 215, and continues to Step 255. At Step 255, the program ends. If at Step 235, the application request status retrieved at Step 230 is not equal to 1, the program continues to Step 245. At Step 245, the program checks the timed out counter M of Step 220 is greater than T. T is greater than or equal to 1. If M of Step 220 is greater than T, the program continues to Step 255 where the program ends. If at Step 245, M is less than or equal to T, the program continues to Step 250. At Step 250, the program increments M by 1 and continues to Step 225.

FIG. 3 illustrates the method for completing a task on a secondary device using the application request created by the requesting application hosted on device 140 by using the IP Address of the network router that device 140 is connected to, request type, user unique identifier and passcode to automatically retrieve the application request. If the task completing program is unable to use the IP Address, request type, and the user unique identifier to automatically retrieve the application request of the requesting program, the program can use the passcode and the request type to directly retrieve the application request. The task completing application runs on device 150 and device 160. Device 140 and device 150 is connected directly to the network router 120 and both devices share the same IP address of the network router 120. Device 160 does not share the same IP Address as device 140 and device 150 because it is connected to a different network router with a different IP Address. The method for completing a task created by the application running on device 140 by the task completing application running on either device 150 or device 160 starts at Step 300 and continues to Step 305. At Step 305, the application retrieves the user unique identifier that was previously stored to device memory when the user last successfully signed into the application. The unique identifier is not limited to the user's username or id. It can be any user identifiable data specified by the application. The program then continues to Step 310. At Step 310, the application retrieves the device IP Address of the network router that the device is connected to and continues to Step 315. At Step 315, the program requests the user to enter a passcode. The user can choose to leave the passcode empty. The program then continues to Step 320. At Step 320, the program connects to database server 100 via the network router 120 and the network 110 and uses the unique identifier at Step 305, IP address of Step 310, and the passcode of Step 315 to retrieve the application request generated at Step 215. The program then continues to Step 320 where the program connects to database server 100 via the network router 120 and the network 110 and checks if there is an application request matching either the IP address of Step 310 and the request type or unique identifier of Step 305 and the request type or the passcode of Step 315 and the request type and continues to Step 325. If at Step 325, there is no application request that matches the criteria, the program continues to Step 350 where it ends. If at Step 325, there is a task that matches either the IP address of Step 310 and the request type or the unique identifier of Step 305 and the request type or the passcode of Step 315 and the request type, the program continues to Step 330. At Step 330, the application completes the task by either capturing a picture using the device camera, collect a signature using the touch screen, retrieving data on the device, or any other tasks requiring data collection. Data collection is not limited to using the available hardware of the device. Once the data has been collected, the program continues to Step 340. At Step 340, the program connects to database server 100 via the network router 120 and the network 110 and updates the application request data with the data collected at Step 330 and sets that status of the application request to 1. The program then continues to Step 350 where it ends.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A method for creating an application request comprising the steps of:
(a) getting the user unique identifier stored in device memory
(b) getting the IP address of the network router
(c) creating an application request
(d) checking the application request status equal to 1 using the device request unique identifier at step (b)
(e) retrieving the data from the application request if the application request status equals to 1 at step (c)

2. The method of claim 1, wherein the application request consists of a unique identifier, current date and time, passcode, IP address, status, request type, data and user unique identifier

3. A method for using an IP address and request type, or user unique identifier and request type, or passcode and request type to retrieve an application request comprising the steps of:
(a) getting the user unique identifier stored in device memory
(b) getting the IP address of the network router
(c) getting a passcode from the user
(d) connecting to the database server
(e) retrieving the application request using the user unique identifier at step (a) in combination with the request type or using the IP address of step (b) in combination with the request type or passcode of step (c) in combination with the request type
(f) retrieving data from the device
(g) submitting the data of step (f) to the database server
(h) setting the status of the application request to 1

4. The method of claim 3, wherein the data is created by using the device hardware or data stored in device memory

5. A system for completing a task created by an application using a secondary device comprising:
(a) the requesting application and task completing application run on devices that are either connected to the same network router or different network router
(b) the devices hosting the requesting application and task completing application are connected to the Internet and/or local area network
(c) the devices hosting the requesting application and task completing application are connected to the same database server
(d) the requesting application running on a device creates an application request and waits for another device to complete the application request
(e) the task completing application running on a device is use to complete the application request by collecting data using its hardware or data on the device
